(19) United States
(12) Patent Application Publication
(10) Pub. No.: US 2026/0131822 A1
(43) Pub. Date: May 14, 2026

(54) AUTOREGRESSIVE MODELS FOR AUTONOMOUS AGENTS

(71) Applicant: GM Cruise Holdings, LLC, San Francisco, CA (US)

(72) Inventors: Xin Huang, Santa Clara, CA (US); Eric Wolff, Zephyr Cove, NV (US); Paul Vernaza, Sunnyvale, CA (US); Tung Phan, Garden Grove, CA (US); Mark Edmonds, Somerville, MA (US); Brian Pierce, Trinity, FL (US); Pratik Elias Jacob, Sunnyvale, CA (US); Yuning Chai, San Mateo, CA (US)

(73) Assignee: GM Cruise Holdings, LLC, San Francisco, CA (US)

(21) Appl. No.: 19/335,759

(22) Filed: Sep. 22, 2025

Related U.S. Application Data
(60) Provisional application No. 63/720,679, filed on Nov. 14, 2024.

(51) Int. Cl. B60W 60/00; B60W 50/00; G06N 3/0455

(52) U.S. Cl. CPC B60W 60/001; B60W 50/0097; G06N 3/0455; B60W 2556/10; B60W 2556/40

(57) ABSTRACT

A method for generating a motion plan for an autonomous agent includes obtaining scene data for an agent's environment, including map data and historical state data for one or more objects. A transformer-based encoder generates a set of scene embedding tokens from the scene data to represent a fixed environmental context. A transformer-based decoder autoregressively generates a sequence of action tokens representing a future trajectory. The generation of each subsequent action token is based on the scene embedding tokens and previously generated tokens. Each action token is selected from a discrete action space of unique Verlet actions, which represent accelerations. A future trajectory is determined from the sequence of action tokens and provided to a motion planning module of the autonomous agent.

### CROSS-REFERENCE TO RELATED APPLICATION

This U.S. patent application claims priority under 35 U.S.C. § 119(e) to U.S. Provisional Application 63/720,679, filed on Nov. 14, 2024. The disclosure of this prior application is considered part of the disclosure of this application and is hereby incorporated by reference in its entirety.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to machine learning for autonomous systems, and more specifically to systems and methods for modeling the behavior of agents in a dynamic environment. In the field of autonomous driving, predicting the future behavior of the autonomous vehicle and other agents in its vicinity, such as other vehicles and pedestrians, is fundamental for safe and effective motion planning. A behavior model is responsible for processing complex environmental information to generate one or more plausible future trajectories. This information typically includes static elements, such as road maps and lane boundaries, as well as dynamic elements, such as the historical states (e.g., position, velocity) of various agents in the scene.

Systems may employ machine learning models, including those with encoder-decoder architectures, to perform this task. An encoder module may be used to process the varied inputs from the environment into a condensed representation of the scene. A decoder module then uses this representation to generate a predicted future trajectory for an agent. In some configurations, these models are trained to output a full, multi-step trajectory in a single forward pass.

A method for representing a predicted trajectory is as a sequence of future spatial coordinates. However, generating trajectories in this manner can present challenges. The resulting sequence of points may lack smoothness or fail to conform to the physical and kinematic constraints of vehicle motion, potentially producing trajectories that are noisy or contain jitter. Such outputs may require additional post-processing steps to smooth the trajectory and ensure it is physically plausible before it can be used by a vehicle's planning or control systems.

Furthermore, behavior models for autonomous vehicles must operate under strict, real-time computational constraints. The model must generate predictions with very low latency to allow the vehicle to react to changing conditions. Models that generate complex outputs sequentially can be computationally demanding, as each step in the generation process may require a full pass through the network. This computational burden presents a significant challenge for deployment on the resource-constrained data processing hardware typically available within a vehicle, potentially making it difficult to achieve the low-latency performance required for safe operation.

### SUMMARY

One aspect of the disclosure provides a method that executes on data processing hardware that causes the data processing hardware to perform operations. The operations include obtaining scene data for an environment of the autonomous agent, the scene data including map data and historical state data for one or more objects within the environment. The operations include generating a set of scene embedding tokens based on the scene data using a transformer-based encoder, the set of scene embedding tokens representing a fixed context of the environment. The operations include autoregressively generating a sequence of action tokens representing a future trajectory for the autonomous agent using a transformer-based decoder. For each time step in a prediction horizon, the transformer-based decoder is configured to generate a subsequent action token based on the set of scene embedding tokens and one or more previously generated action tokens in the sequence. Each action token is selected from a discrete action space having a plurality of unique Verlet actions that represent respective accelerations of the autonomous agent. The operations also include determining the future trajectory for the autonomous agent based on the generated sequence of action tokens and providing the future trajectory to a motion planning module of the autonomous agent.

Implementations of the disclosure may include one or more of the following optional features. In some implementations, autoregressively generating the sequence of action tokens involves caching key and value matrices determined by the transformer-based decoder that are based on the set of scene embedding tokens, and reusing the cached key and value matrices during generation of two or more subsequent action tokens in the sequence to reduce computational latency.

In some examples, determining the future trajectory includes generating a plurality of distinct sequences of action tokens by sampling the transformer-based decoder a plurality of times; determining a corresponding plurality of distinct future trajectories based on the plurality of distinct sequences of action tokens; and applying a K-Means clustering algorithm to the plurality of distinct future trajectories to select a subset of representative future trajectories. In some implementations, determining the future trajectory includes determining each subsequent state in the future trajectory from a current state and a previous state based on an acceleration corresponding to a respective action token in the sequence of action tokens.

Optionally, the historical state data for the one or more objects includes one or more kinematic features selected from the group consisting of: a position; an orientation; a velocity; and an acceleration. In some examples, generating the set of scene embedding tokens includes processing one or more vectors representing the scene data with a PointNet-style encoder to generate initial token embeddings prior to fusion by a self-attention transformer module.

The operations may further include, prior to obtaining the scene data, training the transformer-based decoder using a teacher forcing methodology, where ground-truth future positions of an agent are provided as input to the transformer-based decoder during training. In some of these examples, training the transformer-based decoder involves minimizing a cross-entropy classification loss over the discrete action space. Training the transformer-based decoder may also involve pre-training the transformer-based decoder on a first dataset of driving demonstrations and subsequently fine-tuning the pre-trained transformer-based decoder on a second dataset, the second dataset smaller than the first dataset.

In some implementations, the autonomous agent is a vehicle. In these implementations, providing the future trajectory to the motion planning module involves providing the future trajectory for controlling one or more of a steering system, a braking system, or an acceleration system of the vehicle.

Another aspect of the disclosure provides a system. The system includes data processing hardware and memory hardware in communication with the data processing hardware. The memory hardware stores instructions that when executed on the data processing hardware cause the data processing hardware to perform operations. The operations include obtaining scene data for an environment of the autonomous agent, the scene data including map data and historical state data for one or more objects within the environment. The operations include generating a set of scene embedding tokens based on the scene data using a transformer-based encoder, the set of scene embedding tokens representing a fixed context of the environment. The operations include autoregressively generating a sequence of action tokens representing a future trajectory for the autonomous agent using a transformer-based decoder. For each time step in a prediction horizon, the transformer-based decoder is configured to generate a subsequent action token based on the set of scene embedding tokens and one or more previously generated action tokens in the sequence. Each action token is selected from a discrete action space having a plurality of unique Verlet actions that represent respective accelerations of the autonomous agent. The operations also include determining the future trajectory for the autonomous agent based on the generated sequence of action tokens and providing the future trajectory to a motion planning module of the autonomous agent.

This aspect may include one or more of the following optional features. In some implementations, autoregressively generating the sequence of action tokens involves caching key and value matrices determined by the transformer-based decoder that are based on the set of scene embedding tokens, and reusing the cached key and value matrices during generation of two or more subsequent action tokens in the sequence to reduce computational latency.

In some examples, determining the future trajectory includes generating a plurality of distinct sequences of action tokens by sampling the transformer-based decoder a plurality of times; determining a corresponding plurality of distinct future trajectories based on the plurality of distinct sequences of action tokens; and applying a K-Means clustering algorithm to the plurality of distinct future trajectories to select a subset of representative future trajectories. In some implementations, determining the future trajectory includes determining each subsequent state in the future trajectory from a current state and a previous state based on an acceleration corresponding to a respective action token in the sequence of action tokens.

Optionally, the historical state data for the one or more objects includes one or more kinematic features selected from the group consisting of: a position; an orientation; a velocity; and an acceleration. In some examples, generating the set of scene embedding tokens includes processing one or more vectors representing the scene data with a PointNet-style encoder to generate initial token embeddings prior to fusion by a self-attention transformer module.

The operations may further include, prior to obtaining the scene data, training the transformer-based decoder using a teacher forcing methodology, where ground-truth future positions of an agent are provided as input to the transformer-based decoder during training. In some of these examples, training the transformer-based decoder involves minimizing a cross-entropy classification loss over the discrete action space. Training the transformer-based decoder may also involve pre-training the transformer-based decoder on a first dataset of driving demonstrations and subsequently fine-tuning the pre-trained transformer-based decoder on a second dataset, the second dataset smaller than the first dataset.

In some implementations, the autonomous agent is a vehicle. In these implementations, providing the future trajectory to the motion planning module involves providing the future trajectory for controlling one or more of a steering system, a braking system, or an acceleration system of the vehicle.

Another aspect of the disclosure provides a vehicle. The vehicle includes data processing hardware and memory hardware in communication with the data processing hardware. The memory hardware stores instructions that when executed on the data processing hardware cause the data processing hardware to perform operations. The operations include obtaining scene data for an environment of the autonomous agent, the scene data including map data and historical state data for one or more objects within the environment. The operations include generating a set of scene embedding tokens based on the scene data using a transformer-based encoder, the set of scene embedding tokens representing a fixed context of the environment. The operations include autoregressively generating a sequence of action tokens representing a future trajectory for the autonomous agent using a transformer-based decoder. For each time step in a prediction horizon, the transformer-based decoder is configured to generate a subsequent action token based on the set of scene embedding tokens and one or more previously generated action tokens in the sequence. Each action token is selected from a discrete action space having a plurality of unique Verlet actions that represent respective accelerations of the autonomous agent. The operations also include determining the future trajectory for the autonomous agent based on the generated sequence of action tokens and providing the future trajectory to a motion planning module of the autonomous agent.

### BRIEF DESCRIPTION OF THE DRAWINGS

The drawings described herein are for illustrative purposes only of selected configurations and are not intended to limit the scope of the present disclosure.

FIG. 1 is a schematic view of an exemplary system for generating and deploying a behavior model for an autonomous agent.

FIG. 2 is a block diagram illustrating an exemplary architecture for a behavior model having a transformer encoder and a transformer decoder.

FIG. 3 is a flowchart of an exemplary arrangement of operations for a method of generating a future trajectory for an autonomous agent.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Behavior models for autonomous agents, such as autonomous vehicles, are tasked with predicting the future actions of the agent and other entities in the surrounding environment. These predictions are critical for safe and effective motion planning, motion prediction, and for generating realistic agent behavior in simulation environments. Conventional models often generate a future trajectory as a sequence of discrete position coordinates. However, this approach may result in trajectories that are not kinematically smooth, exhibiting jitter or unrealistic changes in direction that do not adhere to the physical constraints of an agent's motion. These noisy outputs often require computationally intensive post-processing steps to smooth the trajectory before it can be used by a vehicle's control systems, adding to overall system latency.

Furthermore, deploying sophisticated behavior models on the resource-constrained computing hardware typically found within an autonomous vehicle presents a significant technical hurdle. Some behavior models, particularly those that generate long prediction horizons, employ an autoregressive process where each step of the future trajectory is generated sequentially. This sequential generation can be computationally expensive, as each step may involve a full pass through a large neural network. The cumulative latency of this process can make it difficult to meet the strict real-time requirements for safe vehicle operation, where decisions must be made in fractions of a second. This computational bottleneck limits the complexity and predictive accuracy of models that can be practically deployed in a real-world setting.

The systems and methods disclosed herein provide a technical solution for generating smooth, physically plausible, and computationally efficient motion plans for an autonomous agent. In some examples, a method involves obtaining scene data, including map data and historical state data for objects in an environment. A transformer-based encoder processes this data to generate a set of scene embedding tokens, which represent a fixed context of the environment. A transformer-based decoder autoregressively generates a sequence of action tokens representing a future trajectory. Each action token is selected from a discrete action space of unique Verlet actions, where each Verlet action represents a respective acceleration of the agent. By generating a sequence of accelerations rather than positions, the system inherently produces a kinematically smooth trajectory. The final future trajectory, determined from this sequence of action tokens, is then provided to a motion planning module of the autonomous agent.

The disclosed implementations provide several technical benefits and improvements to the functionality of the underlying computing systems. By representing the output as a sequence of Verlet actions, the method improves the quality of the computer-generated trajectory itself. This approach obviates the need for separate, computationally expensive post-processing algorithms for trajectory smoothing, thereby reducing the overall number of floating-point operations required to generate a usable motion plan. This reduction in computational load is a direct improvement to the computer's performance, enabling faster and more efficient real-time decision-making on the resource-constrained processing hardware of an autonomous agent.

Moreover, the systems and methods may employ specific techniques to address the computational demands of the autoregressive generation process. For example, during the generation of the action token sequence, key and value matrices computed by the transformer-based decoder from the static scene embedding tokens may be cached. These cached matrices are then reused for the generation of subsequent action tokens in the sequence. This caching mechanism avoids redundant computations within the decoder's attention layers, leading to a significant reduction in inference latency. This technical improvement to the computer's operation makes it feasible to deploy more complex and accurate autoregressive models in real-time applications, such as autonomous driving, directly enhancing the safety and responsiveness of the autonomous agent by enabling faster and more informed planning cycles.

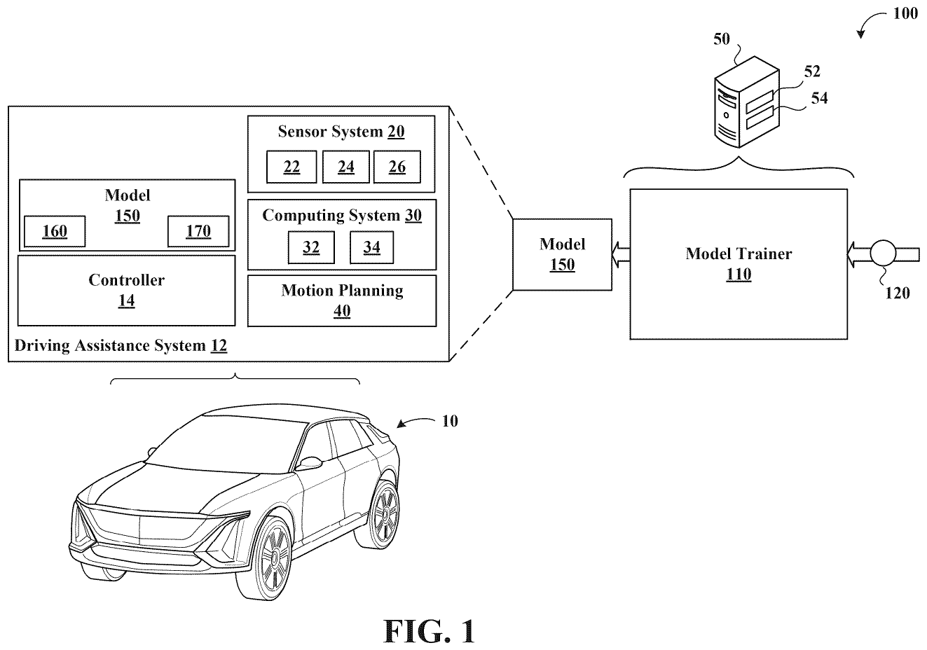

Referring to FIG. 1, a system 100 for generating a motion plan for an autonomous agent is shown. The system 100 includes a remote computing system 50 and an autonomous agent. While the autonomous agent is depicted as a vehicle 10, the systems and methods described herein are broadly applicable to other types of autonomous agents. Such agents may include, but are not limited to, autonomous mobile robots (AMRs) operating in warehouses, robotic manipulators performing tasks in dynamic environments, unmanned aerial vehicles (UAVs), or agricultural and construction equipment. Furthermore, the principles may be applied to simulation systems for modeling agent behavior, such as in air traffic control systems or for pedestrian flow analysis. The remote computing system 50 may be a single computer, multiple computers, or a distributed system, such as a cloud computing environment, having data processing hardware 52 and memory 54. The memory 54 stores instructions that, when executed by the data processing hardware 52, configure the remote computing system 50 to operate as a model trainer 110. The model trainer 110 is configured to generate a behavior model 150, which is then deployed to the vehicle 10 for use by an onboard driving assistance system 12. While described as a remote system, in some implementations, the functionality of the model trainer 110 may be performed in whole or in part on computing resources located within the vehicle 10.

The model trainer 110 is configured to perform operations to train the behavior model 150 using a dataset of driving demonstrations 120. In some examples, the model trainer 110 trains the behavior model 150 using a teacher forcing methodology. In this approach, during training, the model is provided with ground-truth future positions of an agent from the dataset 120, which allows for efficient, parallelized learning. The training process is guided by the minimization of a loss function, such as a cross-entropy classification loss, calculated over the model's predicted action space. Furthermore, the model trainer 110 may employ a pre-training and fine-tuning strategy. For instance, the behavior model 150 may be pre-trained on a first, large-scale dataset of driving demonstrations and subsequently fine-tuned on a second, smaller or more specialized dataset to adapt its performance for a particular environment or task.

The behavior model 150, based on its architecture, demonstrates advantageous scaling properties and strong generalization. In some implementations, the performance of the behavior model 150 on driving-related prediction tasks is observed to improve as the size of the model, defined for example by the number of parameters, and the size of the training dataset 120 are increased. This scaling property is a characteristic of the autoregressive transformer-based decoder 170, which demonstrates more favorable performance improvements compared to alternative architectures, such as one-shot decoders that attempt to predict an entire trajectory in a single forward pass. Furthermore, the architecture exhibits strong generalization capabilities. For example, a behavior model 150 that is pre-trained on a first, large-scale dataset and subsequently fine-tuned on a second, smaller dataset may outperform a model trained exclusively on the second dataset. This indicates that the model learns fundamental representations of driving behavior that are transferable across different datasets and operating environments.

The behavior model 150 is executed by an onboard computing system 30 within the vehicle 10. The computing system 30 includes its own data processing hardware 32 and memory 34 and is configured to perform operations for generating a motion plan in real-time. The process begins when the computing system 30 obtains scene data for the environment of the vehicle 10. This scene data is acquired from an onboard sensor system 20, which may include one or more cameras 22, radar sensors 24, or lidar sensors 26. The scene data includes map data, such as lane boundaries and road geometry, and historical state data for one or more objects within the environment. The historical state data for the vehicle 10 and other objects, such as other vehicles or pedestrians, may include kinematic features, such as position, orientation, velocity, and acceleration, size, as well as attribute features, such as an object type (e.g., car, truck, or pedestrian) or a blinker status.

Once the scene data is obtained, the computing system 30 generates a set of scene embedding tokens using a transformer-based encoder 160. This encoder 160 processes the various inputs. In some implementations, the inputs are first normalized to an agent-centric coordinate frame to provide a consistent frame of reference for the model. The processing may then involve using a PointNet-style architecture to generate initial token embeddings from the normalized, vectorized scene data, and these embeddings are subsequently fused using a self-attention transformer module. The resulting set of scene embedding tokens represents a fixed context of the environment for a given prediction cycle. Next, a transformer-based decoder 170 autoregressively generates a sequence of action tokens representing a future trajectory for the vehicle 10. For each time step in a defined prediction horizon, the decoder 170 generates a subsequent action token based on the fixed set of scene embedding tokens and the sequence of one or more action tokens that have been previously generated.

Each action token generated by the transformer-based decoder 170 is selected from a discrete action space comprising a plurality of unique Verlet actions, where each Verlet action represents a respective acceleration of the vehicle 10. This approach of generating a sequence of accelerations, rather than positions, provides several technical advantages. First, it inherently produces a kinematically smooth and physically plausible trajectory without requiring a separate post-processing smoothing step. Second, the action space of accelerations is more easily normalized. For example, a zero-acceleration action represents a consistent and physically meaningful baseline, such as maintaining a constant velocity, regardless of the agent's location or speed. This is distinct from predicting absolute positions, where the scale and meaning of the output depend entirely on the global coordinate frame. Third, the action space is more intuitive for sampling plausible future actions. The system may sample from a defined and constrained range of physically reasonable accelerations, such as between −3 and +3 meters per second squared, which is a more direct method for generating plausible maneuvers than sampling in a global position space. In some examples, this discrete action space is substantially dense, including at least an order of magnitude more unique actions than other systems, which allows the model to generate more precise and nuanced trajectories. After the full sequence of action tokens is generated, the computing system 30 determines the future trajectory by calculating each subsequent state from a current state and a previous state based on the acceleration corresponding to each respective action token in the sequence.

To enable real-time performance, the process of autoregressively generating the sequence of action tokens may include specific optimizations. In some examples, the system caches key and value matrices that are determined by the transformer-based decoder 170 based on the static set of scene embedding tokens. By reusing these cached key and value matrices during the generation of two or more subsequent action tokens in the sequence, the system avoids redundant computations and significantly reduces computational latency. Additionally, to account for multiple plausible future behaviors, such as turning left or continuing straight at an intersection, the system may generate a plurality of distinct sequences of action tokens by sampling the decoder multiple times. A K-Means clustering algorithm may be applied to the resulting plurality of distinct future trajectories to select a subset of representative trajectories that capture the different behavioral modes.

The computing system 30 provides the determined future trajectory to a motion planning module 40, which may be part of or executed by a controller 14. The motion planning module 40 uses this trajectory to generate control signals for the vehicle 10. For example, providing the future trajectory to the motion planning module may include providing the trajectory for controlling one or more of a steering system, a braking system, or an acceleration system of the vehicle 10. The driving assistance system 12 may also include a user interface system for communicating information related to the planned trajectory or system status to a driver.

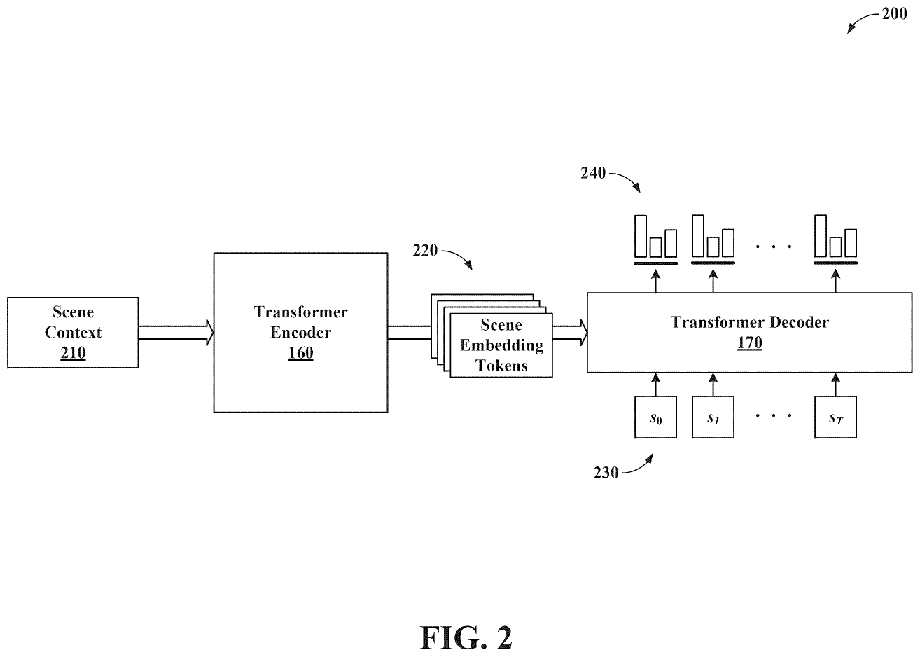

FIG. 2 illustrates a data flow diagram of an exemplary architecture 200 for the behavior model 150 introduced in FIG. 1. The architecture 200 provides a detailed view of the components used to generate a future trajectory for an autonomous agent. The architecture 200 includes a transformer-based encoder 160 that processes environmental information and a transformer-based decoder 170 that autoregressively predicts future actions.

The process begins with obtaining scene data, which is represented as a scene context 210. The scene context 210 is a multi-modal input that may include map data, such as the geometry of lanes and intersections, and historical state data for the autonomous agent and other nearby objects, such as other vehicles and pedestrians. The transformer encoder 160 processes the scene context 210 to generate a set of scene embedding tokens 220. The scene embedding tokens 220 are a fixed-size, numerical representation that summarizes the entire environmental context. This set of tokens serves as a constant, foundational input for the subsequent prediction steps performed by the decoder 170.

The scene embedding tokens 220 are then provided as a conditioning input to the transformer-based decoder 170. In addition to the scene embedding tokens 220, the decoder 170 also receives a sequence of historical agent states 230. These states represent the trajectory of the agent up to the current time step. The decoder 170 is configured to operate autoregressively, similar to a large language model, to predict a sequence of future actions that extend this trajectory.

The decoder 170 is configured to autoregressively generate a sequence of action tokens. Specifically, at each time step in a prediction horizon, the decoder 170 processes the fixed scene embedding tokens 220 and the historical agent states up to that point to predict an output for the next time step. The output is a probability distribution 240 over the discrete action space. As described previously, this action space may be composed of a plurality of unique Verlet actions representing respective accelerations. In other examples, a different discrete tokenization process is used, such as by making use of positions, velocities, jerks, and learned tokenization. An action token is sampled from this distribution 240, and from this action, a new agent state is determined. This new state is then appended to the sequence of historical agent states 230 and used as input for generating the subsequent action token, a process that repeats for the desired prediction horizon.

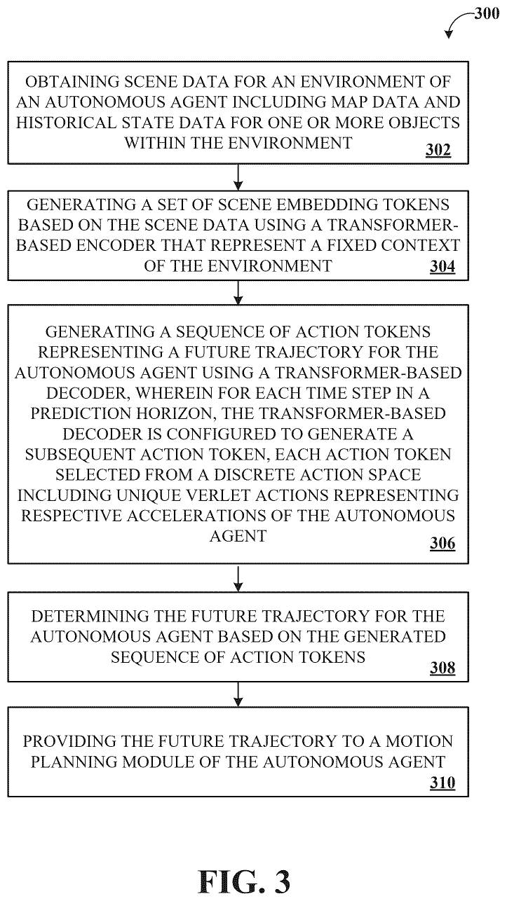

FIG. 3 is a flowchart of an exemplary arrangement of operations for a method 300 for generating a motion plan for an autonomous agent. The method 300 may be performed by data processing hardware 32, such as the onboard computing system 30 of the vehicle 10 described in reference to FIG. 1. The method 300 begins at operation 302, which includes obtaining scene data for an environment of an autonomous agent, the scene data including map data and historical state data for one or more objects within the environment. For example, the computing system 30 obtains real-time data from the sensor system 20. At operation 304, the method 300 includes generating a set of scene embedding tokens based on the scene data using a transformer-based encoder 160. These tokens represent a fixed context of the environment that serves as a foundational input for the prediction process.

The method 300 continues at operation 306, which includes autoregressively generating a sequence of action tokens representing a future trajectory for the autonomous agent using a transformer-based decoder 170. For each time step in a prediction horizon, the decoder 170 is configured to generate a subsequent action token based on the scene embedding tokens and any previously generated action tokens. Each action token is selected from a discrete action space including unique Verlet actions representing respective accelerations of the autonomous agent. At operation 308, the method 300 includes determining the future trajectory for the autonomous agent based on the generated sequence of action tokens. Finally, at operation 310, the method 300 includes providing the determined future trajectory to a motion planning module 40 of the autonomous agent, which uses the trajectory to generate vehicle control commands.

The arrangement of operations in method 300 provides technical improvements to the functionality of the computer systems that execute the method. The combination of generating a sequence of Verlet actions in operation 306 and determining the trajectory from these actions in operation 308 solves the technical problem of generating kinematically unrealistic or noisy trajectories. By generating a sequence of accelerations rather than positions, the method 300 fundamentally changes the nature of the model's output to inherently produce a smooth trajectory. This directly improves the functioning of the computing hardware 32 by obviating the need for separate, computationally expensive post-processing algorithms for trajectory smoothing. This reduction in the total number of required floating-point operations makes the computer more efficient and enables faster real-time decision-making.

Furthermore, the method 300 addresses the technical challenge of high latency in autoregressive models, which can limit their use in real-time systems. Specific implementations of operation 306, such as caching key and value matrices computed from the static scene embedding tokens and reusing them across generation steps, directly reduce the computational burden of the autoregressive process. This caching technique is a specific improvement to the operation of the transformer-based decoder 170, as it avoids redundant computations within its attention mechanisms. This improvement in computational efficiency reduces inference latency, making it feasible to deploy more complex and accurate behavior models on the resource-constrained computing systems 30 found in vehicles. This directly enhances the safety and responsiveness of the autonomous agent by enabling faster and more informed motion planning cycles.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method executing on data processing hardware that causes the data processing hardware to perform operations comprising:
obtaining scene data for an environment of an autonomous agent, the scene data comprising map data and historical state data for one or more objects within the environment;
generating a set of scene embedding tokens based on the scene data using a transformer-based encoder, the set of scene embedding tokens representing a fixed context of the environment;
autoregressively generating a sequence of action tokens representing a future trajectory for the autonomous agent using a transformer-based decoder, wherein for each time step in a prediction horizon, the transformer-based decoder is configured to generate a subsequent action token based on the set of scene embedding tokens and one or more previously generated action tokens in the sequence, each action token selected from a discrete action space comprising a plurality of unique Verlet actions representing respective accelerations of the autonomous agent;
determining the future trajectory for the autonomous agent based on the generated sequence of action tokens; and
providing the future trajectory to a motion planning module of the autonomous agent.

2. The method of claim 1, wherein autoregressively generating the sequence of action tokens comprises:
caching key and value matrices determined by the transformer-based decoder that are based on the set of scene embedding tokens; and
reusing the cached key and value matrices during generation of two or more subsequent action tokens in the sequence to reduce computational latency.

3. The method of claim 1, wherein determining the future trajectory comprises:
generating a plurality of distinct sequences of action tokens by sampling the transformer-based decoder a plurality of times;
determining a corresponding plurality of distinct future trajectories based on the plurality of distinct sequences of action tokens; and
applying a K-Means clustering algorithm to the plurality of distinct future trajectories to select a subset of representative future trajectories.

4. The method of claim 1, wherein determining the future trajectory comprises determining each subsequent state in the future trajectory from a current state and a previous state based on an acceleration corresponding to a respective action token in the sequence of action tokens.

5. The method of claim 1, wherein the historical state data for the one or more objects comprises one or more kinematic features selected from the group consisting of:
a position;
an orientation;
a velocity; and
an acceleration.

6. The method of claim 1, wherein generating the set of scene embedding tokens comprises processing one or more vectors representing the scene data with a PointNet-style encoder to generate initial token embeddings prior to fusion by a self-attention transformer module.

7. The method of claim 1, wherein the operations further comprise, prior to obtaining the scene data, training the transformer-based decoder using a teacher forcing methodology, wherein ground-truth future positions of an agent are provided as input to the transformer-based decoder during training.

8. The method of claim 7, wherein training the transformer-based decoder comprises minimizing a cross-entropy classification loss over the discrete action space.

9. The method of claim 7, wherein training the transformer-based decoder comprises:
pre-training the transformer-based decoder on a first dataset of driving demonstrations; and
subsequently fine-tuning the pre-trained transformer-based decoder on a second dataset the second dataset smaller than the first dataset.

10. The method of claim 1, wherein:
the autonomous agent is a vehicle; and
providing the future trajectory to the motion planning module comprises providing the future trajectory for controlling one or more of a steering system, a braking system, or an acceleration system of the vehicle.

11. A system comprising:
data processing hardware; and
memory hardware in communication with the data processing hardware, the memory hardware storing instructions that when executed on the data processing hardware cause the data processing hardware to perform operations comprising:
obtaining scene data for an environment of an autonomous agent, the scene data comprising map data and historical state data for one or more objects within the environment;
generating a set of scene embedding tokens based on the scene data using a transformer-based encoder, the set of scene embedding tokens representing a fixed context of the environment;
autoregressively generating a sequence of action tokens representing a future trajectory for the autonomous agent using a transformer-based decoder, wherein for each time step in a prediction horizon, the transformer-based decoder is configured to generate a subsequent action token based on the set of scene embedding tokens and one or more previously generated action tokens in the sequence, each action token selected from a discrete action space comprising a plurality of unique Verlet actions representing respective accelerations of the autonomous agent;
determining the future trajectory for the autonomous agent based on the generated sequence of action tokens; and
providing the future trajectory to a motion planning module of the autonomous agent.

12. The system of claim 11, wherein autoregressively generating the sequence of action tokens comprises:
caching key and value matrices determined by the transformer-based decoder that are based on the set of scene embedding tokens; and
reusing the cached key and value matrices during generation of two or more subsequent action tokens in the sequence to reduce computational latency.

13. The system of claim 11, wherein determining the future trajectory comprises:
generating a plurality of distinct sequences of action tokens by sampling the transformer-based decoder a plurality of times;
determining a corresponding plurality of distinct future trajectories based on the plurality of distinct sequences of action tokens; and
applying a K-Means clustering algorithm to the plurality of distinct future trajectories to select a subset of representative future trajectories.

14. The system of claim 11, wherein determining the future trajectory comprises determining each subsequent state in the future trajectory from a current state and a previous state based on an acceleration corresponding to a respective action token in the sequence of action tokens.

15. The system of claim 11, wherein the historical state data for the one or more objects comprises one or more kinematic features selected from the group consisting of:
a position;
an orientation;
a velocity; and
an acceleration.

16. The system of claim 11, wherein generating the set of scene embedding tokens comprises processing one or more vectors representing the scene data with a PointNet-style encoder to generate initial token embeddings prior to fusion by a self-attention transformer module.

17. The system of claim 11, wherein the operations further comprise, prior to obtaining the scene data, training the transformer-based decoder using a teacher forcing methodology, wherein ground-truth future positions of an agent are provided as input to the transformer-based decoder during training.

18. The system of claim 17, wherein training the transformer-based decoder comprises minimizing a cross-entropy classification loss over the discrete action space.

19. The system of claim 17, wherein training the transformer-based decoder comprises:
pre-training the transformer-based decoder on a first dataset of driving demonstrations; and
subsequently fine-tuning the pre-trained transformer-based decoder on a second dataset the second dataset smaller than the first dataset.

20. A vehicle comprising:
data processing hardware; and
memory hardware in communication with the data processing hardware, the memory hardware storing instructions that when executed on the data processing hardware cause the data processing hardware to perform operations comprising:
obtaining scene data for an environment of an autonomous agent, the scene data comprising map data and historical state data for one or more objects within the environment;
generating a set of scene embedding tokens based on the scene data using a transformer-based encoder, the set of scene embedding tokens representing a fixed context of the environment;
autoregressively generating a sequence of action tokens representing a future trajectory for the autonomous agent using a transformer-based decoder, wherein for each time step in a prediction horizon, the transformer-based decoder is configured to generate a subsequent action token based on the set of scene embedding tokens and one or more previously generated action tokens in the sequence, each action token selected from a discrete action space comprising a plurality of unique Verlet actions representing respective accelerations of the autonomous agent;
determining the future trajectory for the autonomous agent based on the generated sequence of action tokens; and
providing the future trajectory to a motion planning module of the autonomous agent.
